(19) United States
(12) Patent Application Publication
(10) Pub. No.: US 2007/0283375 A1
(43) Pub. Date: Dec. 6, 2007

(54) Disc apparatus

(75) Inventors: Kiyofumi Miyake, Yokohama (JP); Takao Naito, Mito (JP); Akinori Shiozawa, Yokohama (JP); Hisataka Sugiyama, Kodaira (JP)

Correspondence Address: TOWNSEND AND TOWNSEND AND CREW, LLP, TWO EMBARCADERO CENTER, EIGHTH FLOOR, SAN FRANCISCO, CA, 94111-3834, US

(73) Assignee: Hitachi, Ltd., Tokyo (JP)

(21) Appl. No.: 11/652,256

(22) Filed: Jan. 10, 2007

(30) Foreign Application Priority Data
Jun. 5, 2006 (JP) 2006-155565

(51) Int. Cl. G11B 17/03

(52) U.S. Cl. 720/695

(57) ABSTRACT

An optical disc apparatus capable of restraining thermal deformation of an optical disc due to transmission of a heat from a spindle motor to the disc, comprises a turn table rotated by the spindle motor, for holding the disc, a bearing portion provided in the spindle motor, for holding a rotary shaft of the table, and a cooling element provided at the outer periphery of the bearing portion, for thermoelectrically cooling the bearing portion. The bearing portion can be directly cooled by the cooling element. Since the heat from the spindle motor is transmitted to the table through the bearing portion, the heat generated from the motor can be prevented from being transmitted to the table by cooling the bearing portion, and further, the table can be cooled. Thus, no heat is transmitted from the table to the optical disc, thereby thermal deformation of the optical disc can be retrained.

### INCORPORATION BY REFERENCE

The present application claims priority from Japanese application JP2006-155565 filed on Jun. 5, 2006, the content of which is hereby incorporated by reference into this application.

### BACKGROUND OF THE INVENTION

The present invention relates to a disc apparatus for rotating a disc, and in particular to an optical disc apparatus which can reduce occurrence of thermal deformation caused in an optical disc.

When a motor is rotated in order to rotate an optical disc, the motor generates, through its rotation, a heat which raises a temperature of a turntable which carries thereon the optical disc, possibly resulting in thermal deformation of the optical disc.

In order to eliminate the above-mentioned problem, the following technology has been proposed.

JP-A-10-83602 discloses an optical disc apparatus which can reduce local thermal deformation of an optical disc, as a main purpose, so as to aim at enhancing the durability and the reliability of the apparatus in its entirety. This apparatus comprises a spindle motor for rotating an optical disc through the intermediary of a turntable, a center position adjusting member for the disc, the adjusting member being located between a guide member fixed to an rotary shaft of the motor and the turntable and adapted to reciprocate along the rotary shaft, the adjusting member being guided by the guide member, and a clamper for holding the optical disc in cooperation with the turntable. The damper is formed from a member having a small thermal conductivity, but an annular clamp member at the outer periphery thereof is formed from a member having a large thermal conductivity. Further, the annular holding member of the turntable is composed of an annular spacer made of an elastic member, and a member arranged on the optical disc side and having a large thermal conductivity.

JP-A-10-43664 discloses a spin coating apparatus capable of maintaining an atmospheric temperature around a disc table, at a predetermined temperature, as a main purpose, having a spindle shaft which is extended in a vertical direction and has a disc-like disc table at its top end, a bearing located below the disc table for rotatably journalling the spindle shaft to a frame, a motor located below the bearing for rotating the spindle shaft, a nozzle located above the disc table for feeding an organic dye solution onto a CD loaded on the disc table, a casing arranged surrounding the outer periphery of the disc table and having an exhaust passage communicated with an exhaust duct, a water cooling means provided around the bearing, wherein an air cooling means is provided around the motor, and the cooling means cools a heat due to the drive of the motor and a friction heat from the bearing.

JP-A-10-70870 discloses a technology such that there is provided a spindle motor which is excellent in heat radiation, and which can prevent detrimental affection upon the performance of the spindle motor by a heat generated from the spindle motor, expansion and deformation and the like.

Optical disc apparatus are now used not only for personal computers and video recorders but also for portable units such as video cameras, and accordingly, there has been a demand for reducing its size and weight. However, the small-sizing of the optical disc apparatus causes problems one of which is thermal deformation of an optical disc caused by a heat generated from a spindle motor provided in the optical disc apparatus. In particular, in comparison with DVDs, an optical disc apparatus utilizing a light beam having a short wavelength (for example 405 nm), such as BD (Blue-ray Disc), HD DVD (High-Definition Digital Versatile Disc) or the like, has a disc-laser distance of not greater than ¼, a disc track pitch not greater than ½ (for example, 0.32 to 0.34 μm), a maximum recording mark length of not greater than ½ (for example, 0.15 to 17 μm). Thus, it requires an extremely high degree of focusing and tracking accuracy in comparison with DVDs, resulting in such a risk that detrimental affection caused by tilting and surface deflection becomes large. Accordingly, in order to ensure a excellent performance of an optical disc apparatus, three has be such a demand that local temperature rise and thermal deformation of an optical disc are restrained by preventing the temperature of a turntable from being raised by a heat during drive of a spindle motor.

Referring to FIG. 3, detailed explanation will now be made of such a situation that the temperature of a turntable is raised by a heat generated from a spindle motor provided in an optical disc apparatus, and as a result, an optical disc is thermally deformed. It is noted that FIG. 3 shows a heat transmission path in a prior art spindle motor.

During recording/reproduction of the optical disc 2, the turntable 10 which carries thereon the optical disc 2 is rotated. At this stage, a current is fed from a spindle motor control circuit 20 to coils 16 wound on laminated cores 15, and accordingly, the coils generate a heat. This heat is then transmitted, as shown by arrows 31 to 35, through the coils 16, the laminated cores 15, a bearing portion 12, a rotary shaft 11 and the turntable 10, successively in this order, and the heat is finally transmitted to a surface of the optical disc 2 which is in contact with the turntable 10. Since the optical disc 2 usually has a laminated structure in which two substrates are bonded with each other, and accordingly, if a temperature difference occurs between the two substrates which therefor causes different degrees of thermal expansion, tilting and surface deflection occur due to thermal deformation. The tilting and the surface deflection hinder precise focusing onto the recording surface of the optical disc, resulting in occurrence of deterioration of the performance of recording and reproduction onto and from the recording disc 2, and accordingly, errors in recording and reproduction will occur. The smaller the size of the optical disc apparatus, the easier the heat transmission from the coils of the spindle motor to the turntable, the above-mentioned problem becomes more severe.

JP-A-10-83602 discloses a cylindrical spacer formed of a member having a low heat conductivity and provided between a turntable and a rotary shaft in a spindle motor in order to restrain heat transmission from the spindle motor to the turntable. Since a heat generated from the spindle motor is transmitted to the turntable through the rotary shaft, the cylindrical space formed of a member having a low heat conductivity can restrain the rate of heat transmission from the spindle motor to the turntable, that is, it can restrain the temperature of the turntable from being raised. However, after long time elapses subsequent to the initial stage of generation of the heat by the spindle motor, the heat is transmitted to the turntable so that temperature thereof eventually becomes high, resulting in thermal deformation of an optical disc due to a difference in temperature between the turntable side and the atmosphere on the side of the optical disc remote from the turntable. Thus, the optical disc causes tilting and surface deflection or run out, and as a result, the performance of recording/reproduction is deteriorated. Furthermore, in the above-mentioned prior art technology, no measure for cooling the turntable have not yet been used, and accordingly, in the case of replacement of optical discs in a condition in which the temperature of the turntable is high due to long time operation of the optical disc apparatus, that is, an optical disc having a temperature substantially equal to the ambient temperature is loaded on the turntable having a high temperature, a heat is transmitted from the turntable to the surface of the optical disc which is in contact with the turntable so as to cause a temperature difference between the two laminated substrates of the optical disc, resulting in tilting and thermal deformation (the temperature of the interior of the apparatus, that is, the turntable is the sum of the ambient temperature and a temperature rise x degC the x is substantially constant, irrespective of environment, but depends upon an operation time of the apparatus. Since the temperature of the optical disc is substantially equal to the embodiment temperature, the temperature of the optical disc is about 40 degC while the temperature of the interior of the apparatus is about 70 degC in the case of outdoor uses in the midsummer season). As a result, there have been caused such a problem that the performance of recording/reproduction of the optical apparatus deteriorates just after the replacement of the optical discs.

JP-A-10-43664 discloses such a prior art technology that a turntable is cooled although no spindle motor is concerned. However, this technology requires the provision of an air cooling system and a water cooling system in the housing of the optical dice apparatus, and as well, a water feed duct and air and water supply units provided outside the casing, and accordingly, connection between the apparatus and such outside units is indispensable, resulting in such a problem that the apparatus is large-sized. Further, in view of such a fact that a bearing for the rotary shaft of the turntable should be arranged outside of the motor in order to cool the bearing, there have been also caused such a problem that the optical disc apparatus is inevitably large-sized.

JP-A-10-70870 discloses a configuration in which a base is located underneath a bearing, and accordingly, although a heat in the lower part of the bearing can be radiated, no heat radiation measures are provided for the upper part of the bearing. Therefore, there would be caused such a problem that a heat is transmitted to the turntable and temperature thereof is raised.

### SUMMARY OF THE INVENTION

Accordingly, an object of the present invention is to provide a small-sized optical disc apparatus capable of restraining thermal deformation of an optical disc, with the provision of, for example, a cooling element at the outer periphery of a bearing portion in a spindle motor in order to prevent the apparatus from being large-sized and also prevent the temperature of a turntable from being raised due to a long time operation of the spindle motor.

To this end, according to the present invention, there is provided an optical disc apparatus utilizing a removable optical disc, and comprising a turntable for holding the optical disc, and a spindle motor composed of a rotary shaft located so as to extend through a rotating center part of the turntable and a substantially cylindrical bearing portion having an outer peripheral part, for holding the rotary shaft, wherein a cooling element is arranged around the outer peripheral part of the bearing portion located in the spindle motor. A heat generated from a coil of the spindle motor is transmitted to the turntable through the bearing portion. Thus, by directly cooling the bearing portion with the use of the cooling element, the heat can be prevented from being transmitted from the coil of the spindle motor to the turntable, and further, the turntable can be cooled. With this configuration, the heat can not be transmitted from the turntable to the optical disc which is therefore restrained from being thermally deformed, thereby it is possible to prevent the optical disc apparatus from being large-sized.

With the configuration stated above, due to the provision of the cooling element at the outer peripheral part of the bearing portion in the spindle motor, the temperature rise of the turntable due to a long time operation of the spindle motor can be prevented while the disc apparatus can be prevented from being large-sized, and further, thermal deformation of the optical disc can be restrained.

### BRIEF DESCRIPTION OF SEVERAL VIEWS OF THE DRAWING

These and other features, objects and advantages of the present invention will become apparent from the following description when taken in conjunction with the accompanying drawings wherein;

FIG. 1 is a view illustrating a configuration, as an example, of a video camera in a first embodiment of the present invention;

FIG. 2 is a cross-sectional view illustrating a spindle motor in the first embodiment of the present invention;

FIG. 3 is a view illustrating, as an example, a temperature transmission path in a conventional spindle motor;

FIG. 4 is a view illustrating, as an example, a temperature transmission path in the spindle motor in the first embodiment of the present invention;

FIG. 5 is a sectional view illustrating, as an example, the spindle motor in the first embodiment of the present invention, as viewed thereabove;

FIG. 6 is a cross-sectional view illustrating, as an example, a spindle motor in a third embodiment of the present invention;

FIG. 7 is a sectional view illustrating, as an example, the spindle motor in the third embodiment of the present invention, as viewed from thereabove;

FIG. 8 is a cross-sectional view illustrating a fourth embodiment of the present invention; and

FIG. 9 is a sectional view illustrating the spindle motor in the fourth embodiment of the present invention, as view thereabove.

### DETAILED DESCRIPTION OF PREFERRED EMBODIMENTS

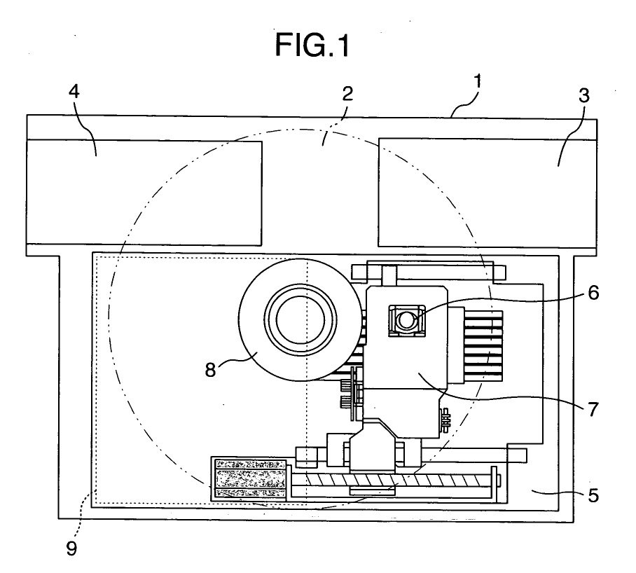

Explanation will be hereinbelow made of preferred embodiments of the present invention in which a video camera using an optical disc apparatus is exemplified, with reference to FIGS. 1, 2 and 4 to 7. It is noted that the present invention should not be limited to these embodiments. The present invention can be applied to the video camera which has a demand for reducing sized and for using outdoor. However, the present invention can be applied to not only the optical disc apparatus used in the video camera but also a general-purpose optical disc apparatus used in any of the other equipment such as a personal computer, a vide tape recorder or the like. Further, the present invention should not be exclusively applied to the optical disc apparatus.

### Embodiment 1

Explanation will be made of a first embodiment of the present invention with reference to FIGS. 1, 2 and 4 to 5.

FIG. 1 shows a configuration of a video camera, as an example, using an optical disc apparatus.

The video camera 1 is composed of an optical disc 2, a camera portion 3, an EVF (Electronic View Finder) 4, and an optical disc apparatus 5. The optical disc apparatus 5 comprises a laser diode 6 that emits a light beam during recording/reproduction, a pick-up 7 incorporating the laser diode 6, a spindle motor 8 for rotating and holding the optical disc 2, and an optical disc apparatus control circuit board 9 for controlling the optical disc apparatus 5.

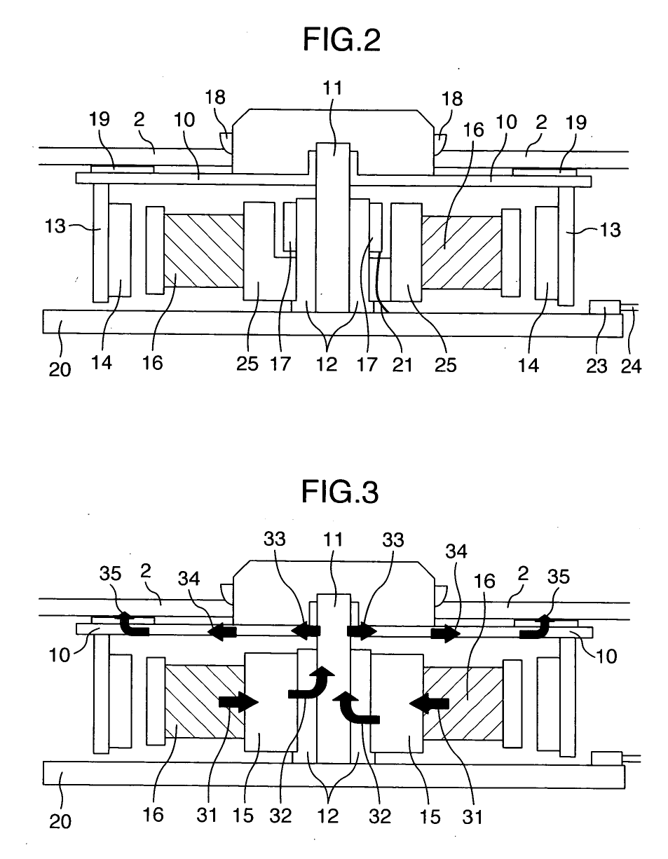

Explanation will be hereinbelow made of the configuration of the spindle motor in the optical disc apparatus with reference to FIGS. 2 and 5. FIG. 2 is a cross-sectional view of the spindle motor and FIG. 5 is a sectional view illustrating the spindle motor as viewed from thereabove. In FIG. 5, a rotor casing and a magnet are not shown. It is noted that the so-called optical disc apparatus may be considered as an apparatus which comprises elements other than the spindle motor as shown in FIG. 1, or as a spindle motor itself.

In this embodiment, the spindle motor 8 is generally referred to as a part other than the optical disc 2, among those shown in FIG. 2. Referring to FIG. 2, there are shown a turn table 10 (which may also be referred to as a base) for rotating and holding the optical disc 2, a rotary shaft 11 of the turn table 10, a bearing portion 12 (over which is coated with an oil for reducing friction, and which may be a ball bearing) for holding the rotary shaft 11, a rotor casing (also termed a cover) 13 press-fitted to the turn table 10, a magnet 14 press-fitted to the rotor casing 13, laminated cores 25 press-fitted to the lower part of the bearing portion 12, coils 16 wound on the laminated cores 25 for generating a magnetic field when a current is fed thereto, a Peltier element 17 as a cooling element annularly bonded to the upper part of the outer peripheral section of the bearing portion 12, press-fit pawls 18 projected leftward and rightward, as viewed in the figure, from the turntable (boss), for securing the optical disc 2, an annular holding member 19 for frictionally holding the optical disc 2, and a spindle motor control circuit board 20 connected to the optical disc apparatus control circuit board 9. A lead wire 21 from the Peltier element 17 is led through a hollow part 22 in the laminated core 25, and is connected to the spindle motor control circuit board 20. Further, the spindle motor control circuit board 20 has a circuit for driving and controlling the peltier element 17. The Peltier element 17 is bonded to the upper part of the outer peripheral section of the bearing portion 12 by use of silicone group resin so as to enhance the thermal conductivity between the Peltier element 17 and the bearing portion 12. That is, the Peltier element 17 and the bearing portion 12 can be fixed together while a heat can be efficiently transmitted therebetween, and accordingly, it is possible to efficiently prevent the heat from being transmitted to the turn table.

It is noted that the spindle motor 8 explained in this embodiment is different from a motor disclosed in JP-A-10-43664 in view of such a configuration that the magnets 14 are rotated together with the turn table 10, and the turn table 10 is coupled thereto with the rotor casing 13, and so forth. The spindle motor 8 may be the one in which the rotary shaft 11 does not rotate but the rotor casing 13 rotates so as to rotate a disc loaded on the turntable 10 together with the disc.

Further, the Peltier element is one of electronic parts having a cooling effect, and is an element utilizing the Peltier effect such that a heat transfers from one to the other of two different kinds of metal parts which are joined together when a current fed to them (Refer to IT Glossary, http://e-words.jp//). Thus, the temperature can be electrically controlled, thereby it is possible to prevent an optical disc apparatus from being large-sized.

Upon recording/reproduction of the optical disc 2, the optical disc 2 is loaded so as to be held by the annular holding member 19 and the press-fit pawls 18. The optical disc 2 which has been held, is rotated at a predetermined speed since the turn table 10 press-fitted to the rotary casing 13 which is rotated by an electromagnetic force between the coils 16 and the magnet 14 in the spindle motor 8 is rotated around the rotary shaft 11 as a center. At this stage, the spindle motor control circuit board 20 delivers a drive instruction to the Peltier element 17 bonded to the upper part of the outer peripheral section of the bearing portion 12 in the spindle motor 8 at the same time as the spindle motor 8 is driven. With this drive instruction, a voltage is applied to the Peltier element 17 for stabilizing the turn table 10 at a predetermined temperature. Since the Peltier element 17 is provided in the spindle motor 8, thereby it is possible to prevent the spindle motor from being large-sized by the provision of the Peltier element 17.

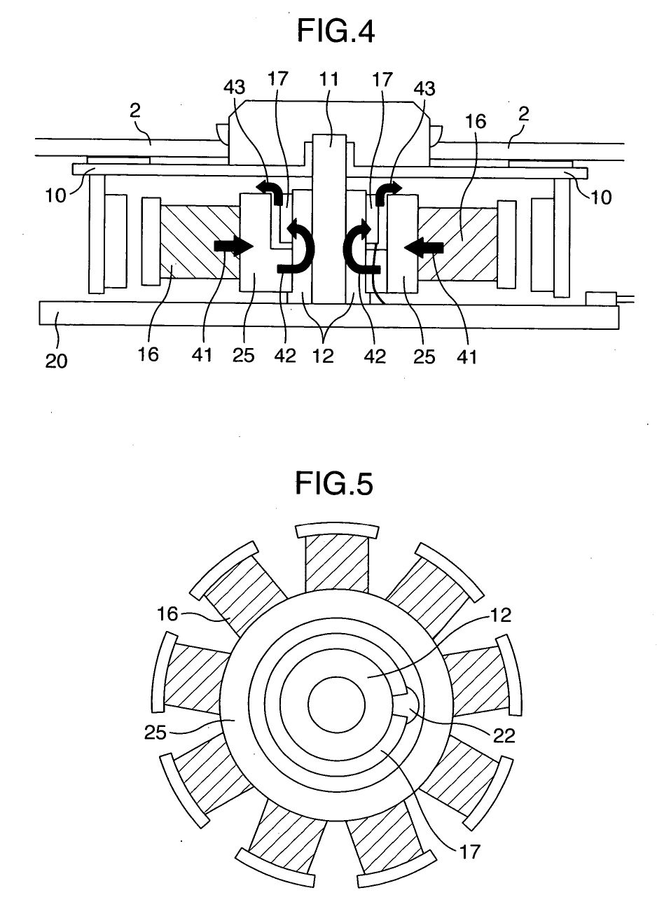

Explanation will be hereinbelow made of a heat transmission path in this embodiment with reference to FIG. 4 which shows a temperature transmission path in the spindle motor.

A heat generated from the coil 16 due to the operation of the spindle motor 8 is transmitted to the laminated core 25 (Refer to the arrow 41). The heat is then transmitted to the lower part of the outer peripheral section of the bearing portion 12 which is in contact with the laminated core 25. At this stage, a substantial part of the heat transmitted to the bearing portion 12 is absorbed (cooled) by the Peltier element 17 (Refer to the arrow 42) since the Peltier element 17 is bonded to the upper part of the outer peripheral section of the bearing portion 12 by use of the silicon resin having a high thermal conductivity. Thereafter, the transmitted heat is radiated from a radiation surface of the Peltier element 17 (Refer to the arrow 43). Thus, the transmission of the generated heat from the coil 16 to the optical disc 2 through the rotary shaft 11 and the turn table 10 is prevented, resulting in reduction of the transmitted heat. Although it may also be considered that the heat source such as the coil 16 is itself cooled, it is efficient to cool the bearing portion 12 through which the heat is directly transmitted to the turn table 10 in order to prevent the temperature rise of the turn table 10. In particular, in such a case that the Peltier element 17 cannot be arranged over the entire vertical length of the bearing portion 12 since the bearing part 12 should be coupled thereto with the laminated core 25, it is effective if the Peltier element 17 is arranged near to the turn table 10. Thus, since the Peltier element 17 serving as a cooling element is arranged at the outer peripheral section of the bearing portion in the spindle motor 8 so as to directly cool the bearing portion 12, the optical disc apparatus or the video camera utilizing the above-described spindle motor can ensure a stable performance of recording/reproduction as well as prevention of being large-sized, and the problem of generation of block noises and the like in the video camera can be restrained.

It is noted here that the voltage applied for energizing the Peltier element 17 is determined by experimentally measuring a temperature difference between the atmospheric temperature outside of the video camera 1 and the temperature of the turn table 10 on condition that the Peltier element 17 is not energized. This measuring is executed as follows: The recording/reproduction of the video camera 1 is carried out for a predetermined time with no energization of the Peltier element 17, and a temperature rise of the turn table 10 relative to the atmospheric temperature outside of the video camera 1 is measured. In such a case that the temperature rise is high, the optical disc 2 is taken out from the video camera 1 and is replaced with another one. As a result, a large difference in temperature was caused between the two substrates of the loaded optical disc, and accordingly, a tilt angle exceeding 0.7 degree which is a maximum permissible level of the standards of optical discs will occur due to thermal deformation.

Thus, a voltage to be applied to the Peltier element 17, with which the temperature difference between the atmospheric temperature outside of the video camera 1 and the turn table 10 can satisfy requirements of the standards of optical discs is experimentally determined. If the thus determined voltage is applied to the Peltier element 17 during recording/reproduction, the temperature of the turn table 10 will substantially equal to the atmospheric temperature outside of the video camera 1, and accordingly, the temperature difference between the two substrates of the optical disc can be decreased even though optical discs are replaced after the optical disc apparatus has been operated for a long time, thereby it is possible to prevent a tilt and a surface deflection.

For example, the recording/reproduction of the video camera 1 in this embodiment was carried out for a predetermined time with no energization of the Peltier element 17, as a result of which, the temperature of the turn table 10 was raised by about 30 degC from the atmospheric temperature outside of the video camera 1 and came into an equilibrium condition. At this stage, the recording/reproduction was once stopped, and the optical disc 2 is taken out in order to replace the same with another one. Accordingly, the thus loaded optical disc exhibited a temperature difference of about 30 degC between its two substrates, resulting in a tilt exceeding an angle of 0.7 deg. which is a maximum permissible level of the standard of optical discs. If this increased degree of the temperature could be cooled by the Peltier element 17, the above-mentioned temperature difference could be decreased and stabilized. Let a voltage applied to the Peltier element 17 equals to A. For example, about 1.0 V as the voltage A was continuously applied to the Peltier element 17 from the spindle motor control circuit board 20 while the spindle motor 8 was driven. After the recording/reproduction was carried out for a predetermined time, the difference between the atmospheric temperature of the video camera 1 and the temperature of the turn table 10 was stabilized within a range of 5 degC. Thus, even just after the replacement of optical discs, a temperature difference between the two substrates of the loaded optical disc was small, thereby a tilt caused by the temperature difference could be restrained to a value not greater than 0.1.

### Embodiment 2

Explanation will be hereinbelow made of a second embodiment of the present invention with reference to FIG. 2. In particular, the video-camera 1 will be exemplified in such a case that the video camera has been used for a long time so as to cause a large temperature difference between the upper space in the video camera above the optical disc 2 and the turn table 10.

The configuration of the second embodiment is the same as that of the first embodiment, except that a voltage to be applied to the Peltier element 17 is determined in a manner different from that in the first embodiment. Same reference numerals are used to denote the same parts to those in the first embodiment, and explanation thereof will be omitted.

In this embodiment, a temperature difference between the upper space in the video camera 1 above the optical disc 2 and the turn table 10 is measured after the recording/reproduction was carried out for a predetermined time, and a voltage B applied to the Peltier element 17 for reducing the temperature difference is experimentally determined. The thus determined applied voltage B is applied to the Peltier element 17 during the recording/reproduction in order to energize the Peltier element 17, and accordingly, the temperature difference between the space in the video-camera 1 above the optical disc 2 and the turn table 10 can be decreased. Thus, ever after a long time operation of the optical disc apparatus, the temperature difference between the two substrates of the optical disc can be decreased, thereby it is possible to restrain a tilt and a surface deflection of the optical disc.

For example, in the case of continuously applying a voltage of 0.5 V to the Peltier element 17 from the spindle motor control circuit board 20, simultaneously with the operation of the spindle motor 8, after the recording/reproduction was carried out for a predetermined time, the temperature difference between the space above the optical disc 2 and the turn table 10 was stabilized within 5 degC. Thus, even after a long time operation for recording/reproduction, a caused tilt of the optical disc 2 could be restrained to an angle not greater than 0.1 deg.

It should be noted here that the above-mentioned applied voltages A, B may be alternatively applied to the Peltier element 17, depending upon different use conditions, and different use times of the optical disc apparatus.

### Embodiment 3

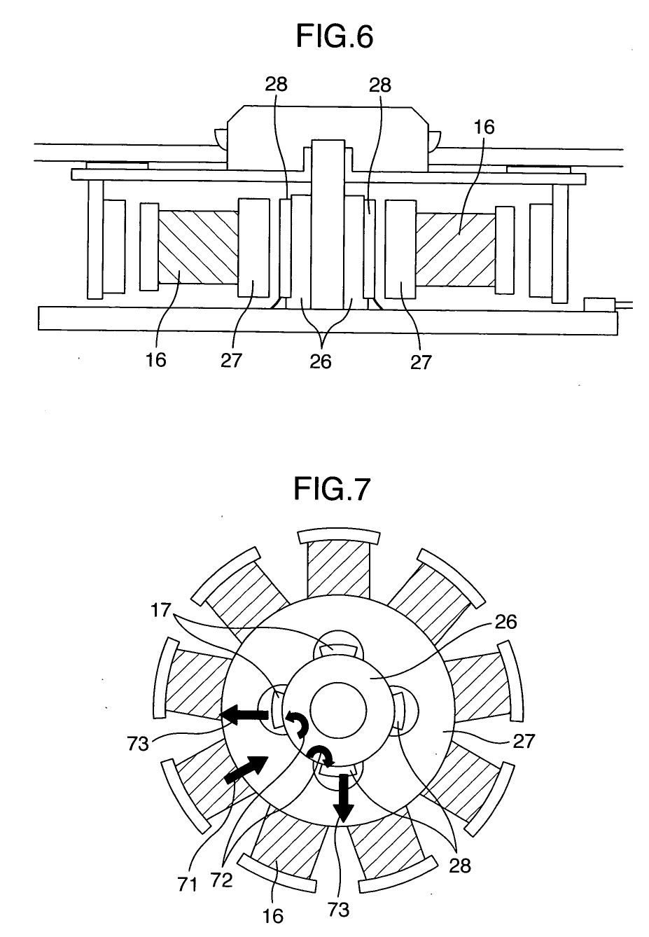

Explanation will be made of a third embodiment of the present invention with reference to FIGS. 6 and 7. FIG. 6 is cross-sectional view illustrating a spindle motor and FIG. 7 is a sectional view illustrating the spindle motor as viewed thereabove. The configuration of the third embodiment is the same as that of the first embodiment, except that a bearing portion 26, a laminated core 27 and a Peltier element 28 have different structures and are arranged different positions from those in the first embodiment. Thus, same reference numerals are used to denote the same parts to those in the first embodiment, and accordingly, the explanation thereto will be omitted.

In this embodiment, four Peltier elements 28 and four laminated cores 27 are alternately press-fitted to the peripheral surface of the bearing portion 26. In this configuration, the temperature transmission path is set as shown in FIG. 7, that is, a heat transmitted from the coils 16 to the laminated cores 27 (Refer to the arrow 71) from which the heat is transmitted to the bearing portion 26 so as to be absorbed (cooled) by the Peltier elements 28 (the arrow 72), and the heat is finally radiated from the radiation surfaces of the Peltier elements 28 (Refer to the arrow 73).

As stated above, even with the above-mentioned configuration, the heat transmitted to the turn table can be effectively prevented, similar to the configuration of the first embodiment.

It should be noted that if the configuration in which the Peltier elements 28 and the laminated cores 27 are both made into contact with the bearing portion 26 can be provided, the bearing portion 26, the laminated cores 27 and the Peltier element 28 may have any shapes and configurations.

### Embodiment 4

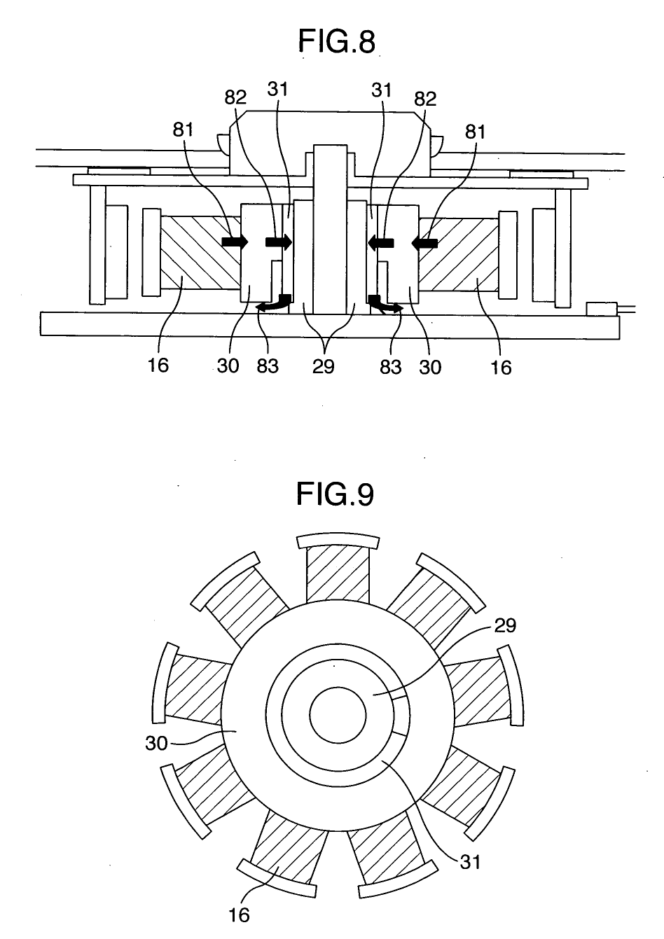

Explanation will be hereinbelow made of a fourth embodiment of the present invention with reference to FIGS. 8 and 9. FIG. 8 is a cross-sectional view illustrating a spindle motor and FIG. 9 is a sectional view illustrating the spindle motor as viewed thereabove. The configuration of the fourth embodiment is the same as that of the first embodiment, except that a bearing portion 29, a laminated core 30 and a Peltier element 31 have different structures and different arrangement. Further, the heat absorbing side of the Peltier element 31 faces toward the laminated cores 30. As for the rest, the same reference numerals are used to denote the same parts to those in the first embodiment, and accordingly, explanation thereto will be omitted.

In the configuration of this embodiment, the Peltier element 31 having such a stiffness that a degree of positional accuracy, with axial runout within, for example, 10 μm is caused, can be maintained is used, and the Peltier element 31 is arranged entirely over the outer peripheral surface of the bearing portion 29, and the laminated cores 30 are arrange around the outer peripheral portion of the Peltier element. In this configuration, the temperature transmission path is set as shown in FIG. 8, that is, a heat is transmitted from the coil 16 to the laminated cores 30 (the arrow 81) from which the heat is absorbed (cooled) by the Peltier element 31 (the arrow 82), and the heat is finally radiated from the radiation surface of the Peltier element 28 (the arrow 83).

As above-mentioned, with the configuration as stated above, no heat is transmitted from the coil 16 to the bearing portion 29, so that, it is possible to obtain such an effect that no heat is transmitted to the turn table.

It should be noted that the configuration in which the Peltier element 31 is provided between the laminated core 30 and the bearing portion 29 will be sufficient, irrespective of shapes and configurations of the bearing portion 29, the laminated core 30, and the Peltier element 30.

While we have shown and described several embodiments in accordance with our invention, it should be understood that disclosed embodiments are susceptible of changes and modifications without departing from the spirit and scope of the invention. Therefore, we do not intend to be bound by the details shown and described herein but intend to cover all such changes and modification that fall with the ambit of the appended claims.

1. A disc apparatus to read data from a rotating disc, comprising:
a portion to read data from the disc,
a bed to load thereon the disc,
a bearing portion coupled to the bed and arranged around a shaft,
a magnet rotated together with the bed,
a coil in cooperation with the magnet, to rotate the bed around the shaft as a center, and
a cooling portion to cool the bearing portion.

2. A disc apparatus to rotate the disc,
a bed to load thereon a disc,
a rotor casing coupled to the bed,
a magnet rotated together with the bed,
a coil in pair with the magnet,
a bearing portion coupled to the bed, and
a cooling portion to cool the bearing portion;
wherein the magnet, the coil and the cooling portion are arranged in the mentioned order from the rotor casing to the rotary shaft.

3. A disc apparatus as set forth in claim 1, wherein a connection between the coil and the bearing portion, the cooling portion and the bed are arranged in the mentioned order, as viewed toward the shaft in the bearing portion.

4. A disc apparatus in which a magnet coupled to a rotor casing is rotated by a magnetic field induced in a coil in order to rotate a disc around a rotary shaft as a center, which is loaded on a turntable coupled to the rotor casing,
wherein a cooling element is arranged between the coil and the rotary shaft.

5. An optical disc apparatus having a spindle motor having a turn table carrying thereon an removable optical disc, a rotary shaft located at a rotating center of the turn table, and a bearing part to hold the rotary shaft
wherein the cooling element is arranged at an outer peripheral part of the bearing portion.

6. An optical disc apparatus as set forth in claim 5, wherein the cooling element and the bearing portion are secured to each other with an adhesive member made of silicon resin.

7. An optical disc apparatus as set forth in claim 5, wherein the cooling element is controlled so as to cause a temperature of the turn table to a predetermined temperature.

8. An optical disc apparatus as set forth in claim 5, wherein the cooling element is a Peltier element.

9. A video camera incorporating an optical disc apparatus as set forth in claim 5.
